(19) United States
(12) Patent Application Publication
(10) Pub. No.: US 2012/0139885 A1
(43) Pub. Date: Jun. 7, 2012

(54) LIQUID CRYSTAL DISPLAY DEVICE

(76) Inventors: Hiroshi IWASA, Hayama (JP); Hidenao Kubota, Yokohama (JP)

(21) Appl. No.: 13/296,274

(22) Filed: Nov. 15, 2011

(30) Foreign Application Priority Data
Dec. 7, 2010 (JP) 2010-272586

(51) Int. Cl. G09G 5/00

(52) U.S. Cl. 345/207

(57) ABSTRACT

According to the present invention, area control of a liquid crystal display device prevents luminance insufficiency attributing to leaking of illumination light between adjacent areas. A peak luminance detector detects a peak luminance area in which a luminance level is equal to or higher than a first threshold. A peripheral luminance detector detects luminance levels of peripheral areas located adjacent to the peak luminance area. When the average of the luminance levels of the peripheral areas is equal to or lower than a second threshold, a peak luminance corrector increases a light source luminance level of a backlight cell that corresponds to the peak luminance area.

### CLAIM OF PRIORITY

The present application claims priority from Japanese patent application serial No. JP 2010-272586, filed on Dec. 7, 2010, the content of which is hereby incorporated by reference into this application.

### BACKGROUND OF THE INVENTION

(1) Field of the Invention

The present invention relates to a liquid crystal display device that has a backlight for illuminating, from a back surface of a liquid crystal panel, the liquid crystal panel for displaying an image, in which luminance of the backlight is controlled according to an image signal for displaying.

(2) Description of the Related Art

A liquid crystal display device is different from light-emitting display devices such as a CRT or plasma display panel in that it includes a non-light-emitting liquid crystal panel (light-transmissive optical modulation element) and a backlight. The backlight is arranged on the back surface of the liquid crystal panel and illuminates the liquid crystal panel. The backlight emits light with constant luminance regardless of image signals so that images with desired brightness is displayed by controlling a light transmittance of the liquid crystal panel according to luminance levels of the image signals. Thus, even when an image is dark, power for a light source of the backlight is constantly consumed but not reduced, leading to the low power efficiency. To take countermeasures for the low power efficiency, the following technique has been proposed: the luminance of the backlight (hereinafter also referred to as backlight luminance) is set to be variable, reducing the power consumption by controlling the backlight luminance and a signal amplitude (light transmittance) of the liquid crystal panel according to amplitude levels of an input image signal. The proposed technique improves the quality of an image. Further, in another known-technique, a display screen and a backlight are each divided into a plurality of regions (areas), and luminance levels for each region of the backlight is controlled on the basis of the image signal. The known-technique is called area control or local dimming.

As a problem with the area control, when a light source that does not emit light is located next to a backlight source emitting light with the maximum luminance, unnatural black floating occurs. This is due to the finiteness of the contrast (variable range of the light transmittance) of the liquid crystal panel. For example, JP-A-2008-51905 discloses that the backlight driving controller has an adjacent region lighting section which lights up at the brightness smaller than the brightness of the lighting division region A with respect to the adjacent region C of the specified width adjacent to the lighting division region A where the backlight is lighted up based on the image signal.

### SUMMARY OF THE INVENTION

In addition to the aforementioned black floating, another problem with the area control is that white peak luminance is insufficient. Specifically, when a white image (high-luminance peak part) is present only in a part of a black background (low luminance), the backlight luminance is insufficient for the white image, leading to the lesser sharpness of the white image. This attributes to the configuration of the area control in which influx/supply of illumination light leaks from an area into another area and vice versa, located adjacent to each other, sharing the leaked illumination light between areas. When a luminance distribution in a screen is uniform (for example, when entire screen displays white), approximately 5% of the illumination light leaks/supplies into/from the areas. On the other hand, when the luminance distribution in the screen is not uniform, the illumination light leaks only one way: from a high-luminance area to a low-luminance area. As a result, when a white image and a black image are adjacent to each other, the illumination light leaks less from the black image (low-luminance area) into the white image (high-luminance area), leading to the insufficiency of the white image luminance. For example, when a white image area is surrounded by black image areas, light does not leak from four black image areas located adjacent to the white image area into the white image area. Thus, the luminance level of the white image area is reduced by 20% in total (4×5%), compared to the case in which entire screen displays white.

The aforementioned light leaking between adjacent areas affects in encouraging black floating in a black image. This is because that the luminance of the black image is not sufficiently lowered due to the leaking of illumination light from the high-luminance area (white image) into the low-luminance area (black image), when a black image and a white image are located adjacent to each other. This is especially noticeable when the black image is surrounded by a white background for approximately 20% of light leaks from four white image areas located adjacent to the black image area into the black image area. As a result, black floating of the black image is significantly noticeable in conjunction with the aforementioned contrast property of the liquid crystal panel.

Although the technique disclosed in JP-A-2008-51905 is effective for a problem caused by the contrast property of the liquid crystal panel, the technique does not solve a problem caused by leaking of illumination light between adjacent areas.

An object of the present invention is to provide a liquid crystal display device that prevents luminance insufficiency attributing to leaking of illumination light between adjacent areas and the black floating.

According to an aspect of the present invention, there is provided a liquid crystal display device including: a liquid crystal panel which displays an image; and a backlight which illuminates the liquid crystal panel with light; the liquid crystal panel including a display screen divided into a plurality of areas; the backlight including a plurality of backlight cells that correspond to the areas; an area controller which individually sets light source luminance levels of the backlight cells in accordance with luminance levels of an image signal for the areas; a peak luminance detector which detects a peak luminance area in which a luminance level of the area is equal to or higher than a first threshold; a peripheral luminance detector which detects luminance levels of peripheral areas located adjacent to the peak luminance area; and a peak luminance corrector which corrects the light source luminance levels of the backlight cells, which is set by the area controller; wherein when the average value of the luminance levels of the peripheral areas is equal to or lower than a second threshold, the peak luminance corrector corrects a light source luminance level of a backlight cell corresponding to the peak luminance area so that the corrected luminance level is increased.

According to another aspect of the present invention, there is provided a liquid crystal display device including: a liquid crystal panel which displays an image; and a backlight which illuminates the liquid crystal panel with light; the liquid crystal panel including a display screen divided into a plurality of areas; the backlight including a plurality of backlight cells that correspond to the areas; an area controller which individually sets light source luminance levels of the backlight cells in accordance with luminance levels of an image signal for the areas; a peak luminance detector which detects a peak luminance area in which a luminance level of the area is equal to or lower than a fourth threshold; a peripheral luminance detector which detects luminance levels of peripheral areas located adjacent to the peak luminance area; and a peak luminance corrector which corrects the light source luminance levels of the backlight cells, which is set by the area controller; wherein when the average value of the luminance levels of the peripheral areas is equal to or higher than a fifth threshold, the peak luminance corrector corrects a light source luminance level of a backlight cell corresponding to the peak luminance area so that the corrected luminance level is reduced.

According to the present invention, it is possible to provide a liquid crystal display device that prevents luminance insufficiency attributing to leaking of illumination light between adjacent areas the black floating.

### BRIEF DESCRIPTION OF THE DRAWINGS

These and other features, objects and advantages of the present invention will become more apparent from the following description when taken in conjunction with the accompanying drawings wherein:

FIG. 1 is a block diagram illustrating an example of a liquid crystal display device according to the present invention;

FIG. 2A is a diagram illustrating the configuration of a liquid crystal panel;

FIGS. 2B and 2C are diagrams illustrating the configuration of a backlight;

FIG. 3 is a diagram illustrating an example of a display screen on which luminance control according to a first embodiment is performed;

FIG. 4 is a diagram illustrating another example of the display screen on which the luminance control according to the first embodiment is performed;

FIGS. 5A and 5B are diagrams illustrating an improved effect of the display screen according to the first embodiment;

FIG. 6 is a diagram illustrating a comparison of backlight luminance levels of high-luminance areas illustrated in FIGS. 5A and 5B;

FIG. 7 is a flowchart of the luminance control according to the first embodiment;

FIG. 8 is a diagram illustrating an example of a display screen on which luminance control according to a second embodiment is performed; and

FIG. 9 is a flowchart of the luminance control according to the second embodiment.

### DETAILED DESCRIPTION OF THE EMBODIMENTS

Embodiments of the present invention are described with reference to the accompanying drawings.

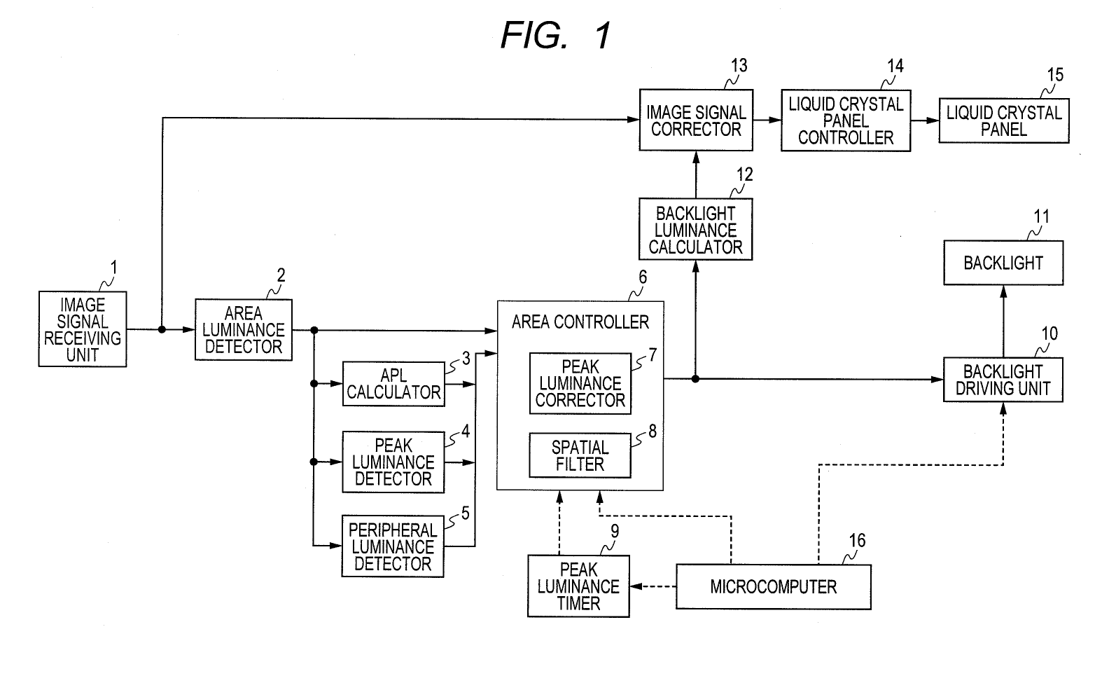

FIG. 1 is a block diagram illustrating an example of a liquid crystal display device according to the present invention. The liquid crystal display device includes a liquid crystal panel 15 and a backlight 11. The liquid crystal panel 15 displays an image on the basis of an image signal input to the liquid crystal display device, while the backlight 11 illuminates the liquid crystal panel 15 from a backside surface of the liquid crystal panel 15. The liquid crystal display device has an input unit that includes an image signal receiving unit 1, an area luminance detector 2, an APL calculator 3, a peak luminance detector 4 and a peripheral luminance detector 5. The image signal receiving unit 1 receives an image signal. The area luminance detector 2 detects a luminance level of the received image signal in each of areas. The APL calculator 3 calculates an average picture level (APL) of all luminance levels on a display screen. The peak luminance detector 4 detects an area (peak luminance area) in which a luminance level is peaked on the display screen. The peripheral luminance detector 5 detects luminance levels of peripheral areas located adjacent to the peak luminance area. The liquid crystal display device further includes an area controller 6 and a backlight driving unit 10 as a control signal system of the backlight 11. The area controller 6 generates a control signal for the backlight 11 for each of the areas, while the backlight driving unit 10 drives the backlight 11. The area controller 6 includes a peak luminance corrector 7 and a spatial filter 8. The peak luminance corrector 7 corrects a luminance signal of the peak luminance area, while the spatial filter 8 performs a filtering process on luminance signals between adjacent areas. In addition, the liquid crystal display device includes a backlight luminance calculator 12 and an image signal corrector 13 as an image signal system of the liquid crystal panel 15. The backlight luminance calculator 12 calculates backlight luminance levels (luminance levels of illumination light for the areas) on the basis of the control signals generated for the areas, while the image signal corrector 13 corrects an image signal according to the backlight luminance levels. A liquid crystal panel controller 14 drives the liquid crystal panel 15. A microcomputer 16 that serves as a controller controls operations for the units by using a peak luminance timer 9.

The backlight 11 according to the present embodiment includes a plurality of light source blocks (backlight cells) that each have an LED light source. The backlight 11 according to the present embodiment uses an area control method that enables the backlight cells to emit light at different luminance levels (backlight luminance levels). Thus, the area controller 6 sets illumination intensities to corresponding backlight cells according to the luminance levels detected for the areas by the area luminance detector 2. In this case, the peak luminance corrector 7 detects, on the basis of detection results obtained by the peak luminance detector 4 and the peripheral luminance detector 5, an area (peak luminance area) that has a significant difference in luminance levels from those of peripheral areas located adjacent to the peak luminance area. The detection of the peak luminance area subjects to both of the high-luminance area (white image) and the low-luminance area (black image). A backlight cell that corresponds to the peak luminance area is so adjusted that a white image or a black image in the peak luminance area is displayed with the original luminance level by increasing or decreasing the illuminating intensity from the backlight cell.

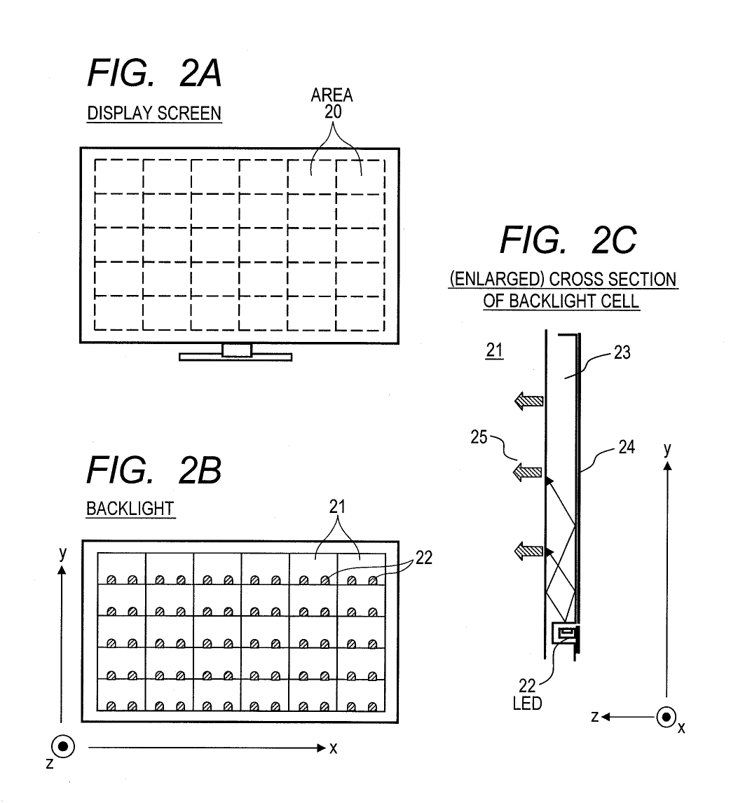

FIG. 2A is a diagram illustrating an example of the configuration of the liquid crystal panel, while FIGS. 2B and 2C are diagrams illustrating an example of the configuration of the backlight. FIG. 2A illustrates the display screen. FIG. 2B illustrates the backlight. FIG. 2C illustrates a cross section of a backlight cell of the backlight.

The display screen of the liquid crystal panel is divided into a plurality of areas 20 that are each constituted by a group of pixels. In this example, the display screen is divided into five sections in the vertical direction and six sections in the horizontal direction of the screen. Thus, in this example, the display screen is divided into thirty rectangular areas 20.

The backlight that corresponds to the display screen is divided into five sections in the vertical direction and six sections in the horizontal direction of the screen so that the backlight has thirty backlight cells 21 arranged in a matrix. The backlight cells 21 illuminate the corresponding areas 20 of the display screen, respectively. The backlight has LED light sources 22 located in lower parts of the backlight cells (a pair of the LED light sources 22 are located in each of the lower parts of the backlight cells in this example). The backlight independently controls the intensity of light on a backlight cell basis.

The backlight cells 21 each include the LED light source 22, a light guide plate 23 and a reflective plate 24. Light emitting from the LED light source 22 is incident on the light guide plate 23 and reflected on the reflective plate 24. Then, the light is output in a direction indicated by arrows 25 (or output toward the left side of FIG. 2C) and serves as illumination light with which the liquid crystal panel 25 is illuminated. The intensity of the light output from each of the LED light sources 22 can be controlled by changing an LED driving current to be supplied from the backlight driving unit 10 to the LED light source 22.

Control of the backlight luminance according to the invention is described below in two embodiments.

### First Embodiment

In the first embodiment, a luminance control for a high-luminance area is described in which a high-luminance image is displayed in a low-luminance background image.

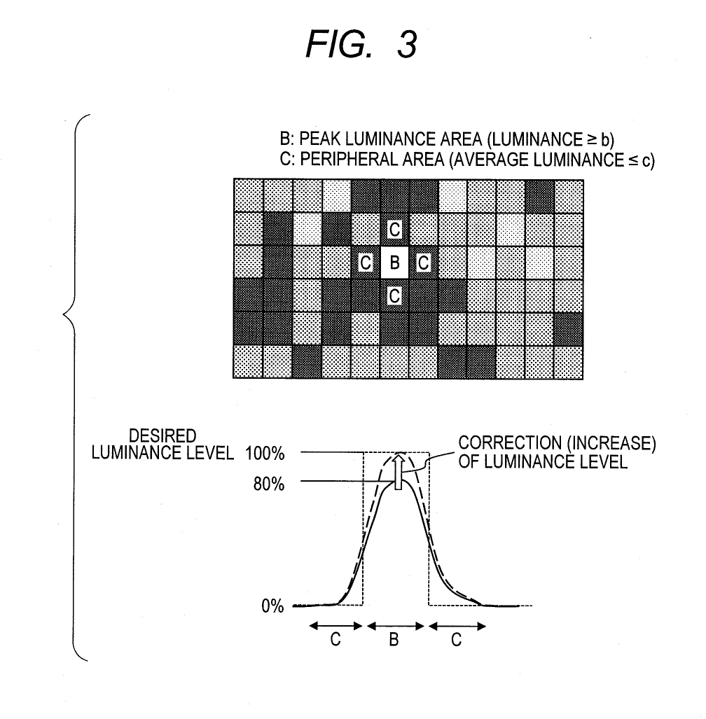

FIG. 3 is a diagram illustrating an example of the display screen on which the luminance control according to the present embodiment is performed. FIG. 3 illustrates the case in which a single high-luminance area is solely present.

The display screen is divided into 12×6 areas. A high-luminance image (white image) is displayed in a low-luminance background image (black image) on the display screen. It is assumed that the high-luminance image is present in a single area B. The area B is hereinafter called a “peak luminance area,” while areas C in which the low-luminance image is displayed and located adjacent to the area B are hereinafter called “peripheral areas.” In this example, four peripheral areas C are present. Light does not leak from the area B into areas diagonally located by the area B (or too minute to count), therefore, those diagonally located areas are not treated as peripheral areas C.

According to the conventional area control, the area B is illuminated with a high backlight luminance level, and the areas C are illuminated with low backlight luminance levels in the display screen. As a result, less light leaks from the areas C into the area B. Thus, the original backlight luminance level (brightness) in the area B cannot be obtained. Four peripheral areas C located adjacent to the single area B are present. Thus, if the luminance level of the area B is reduced by 5% per, peripheral area, the luminance level of the area B is reduced to approximately 80% from the original luminance level. In the present embodiment, the backlight luminance level (current value of the LED light source) of the area B is increased than that of the conventional area control, thereby offsets the shortfall in the luminance level. Specifically, the light source luminance level is corrected to increase by approximately 20% relative to the set value of the backlight luminance level which is determined on the basis of an image signal. This correction enables the backlight luminance level of the area B to become close to a desired brightness level of 100%.

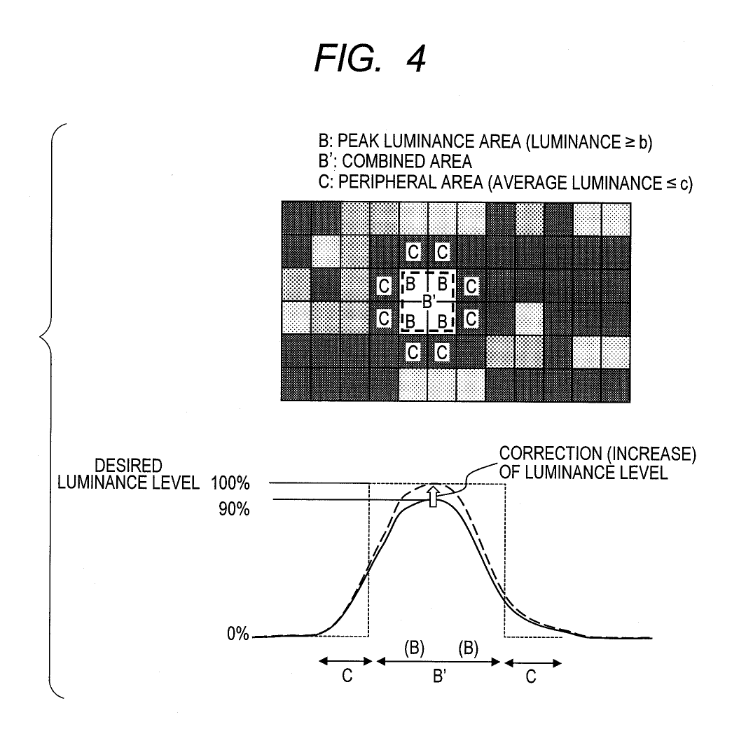

FIG. 4 is a diagram illustrating another example of the display screen on which the luminance control according to the present embodiment is performed. FIG. 4 illustrates the case in which a plurality of high-luminance areas are present and combined.

In this case, a high-luminance image (white image) is displayed in a low-luminance background image (black image), however, the high-luminance images are present in a plurality of peak luminance areas B (four peak luminance areas B in this example). The four peak luminance areas B are combined and collectively called a “combined area B′.” In this case, peripheral areas correspond to low-luminance areas C located adjacent to the combined area B′. In this example, eight peripheral areas are present on the display screen.

According to the conventional area control, less light leaks from the areas C into the combined area B′, lowering a luminance level of the area B′. In this case, however, the luminance level of the area B′ is reduced to approximately 90% from the original luminance level. This is due to the fact that the number of peripheral areas C located adjacent to each of the peal luminance areas B is reduced to two. Thus, the reduction in the luminance level per area B is small, compared to the case in which the four peripheral areas C are located adjacent to the single area B as illustrated in FIG. 3. In this example, the backlight luminance level (current values of the LED light sources) of the combined area B′ is corrected to increase by approximately 10%. This correction enables the backlight luminance level of the combined area B′ to become close to a desired brightness level of 100%.

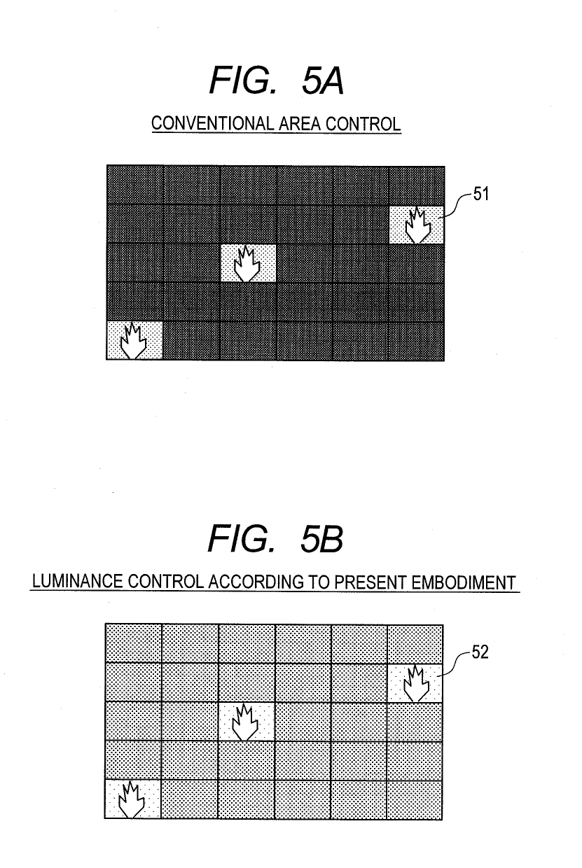

FIGS. 5A and 5B are diagrams illustrating an improved effect of the display screen according to the present embodiment. FIG. 5A illustrates the conventional area control, while FIG. 5B illustrates the luminance control according to the present embodiment. FIGS. 5A and 5B illustrate the case in which high-luminance areas are solely present however, the improved effect also applies to the case in which high-luminance areas are combined.

In the conventional area control, the backlight luminance level of high-luminance areas 51 surrounded by a low-luminance background is insufficient, and a high-luminance image cannot be displayed with the original brightness. On the other hand, in the present embodiment, the backlight luminance level (current value of the LED light sources) of high-luminance areas 52 is corrected and increased, and the high-luminance image can be clearly displayed with the original brightness.

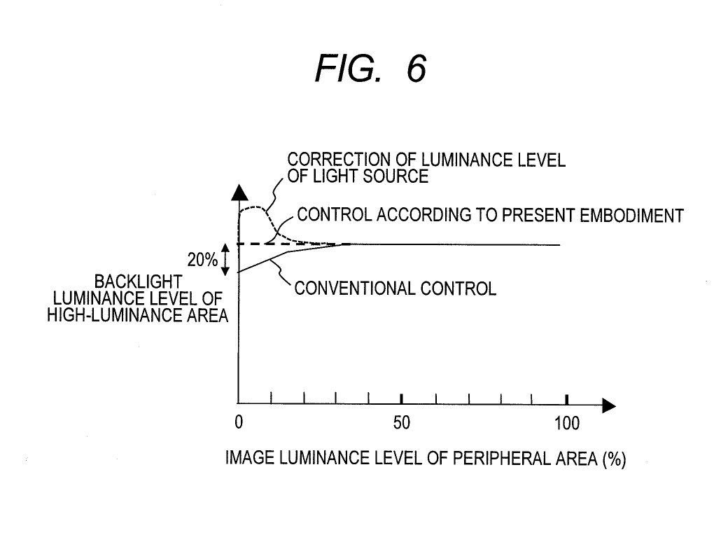

FIG. 6 is a diagram illustrating a comparison of the backlight luminance levels of the high-luminance areas illustrated in FIGS. 5A and 5B. In FIG. 6, the abscissa indicates the luminance level of the image signal of a peripheral area located adjacent to the high-luminance area, while the ordinate indicates a backlight luminance level of the high-luminance area. Although the backlight luminance level of the high-luminance area is lower by 20% than a desired level in the conventional area control, the backlight luminance level of the high-luminance area can be restored to the desired luminance level by the luminance control (correction and increasing of the light source luminance level) according to the present embodiment. The luminance control according to the present embodiment should be applied when the luminance level of the high-luminance area differs greatly from the luminance level of the peripheral area, or in a range of a luminance level of an image signal in the peripheral area is low, for example, is equal to or lower than 20%. If the luminance control according to the present embodiment is applied when the luminance level of the high-luminance area differs a little from the luminance level of the peripheral area, the backlight luminance level of the high-luminance area is excessively corrected. Thus, the backlight luminance level of the high-luminance area can be maintained at a desired level at all times regardless of the luminance level of the image signal in the peripheral area. In addition, the shortfall in the luminance of the high-luminance image is visually related to the APL of luminance levels on the entire display screen. Specifically, As the APL of the luminance levels on the entire display screen lowers, the shortfall in the luminance of the high-luminance image becomes noticeable. Therefore, the luminance control according to the present embodiment is effectively applied when the APL of the luminance levels on the entire display screen is equal to or lowers than a certain level.

One of the examples describes that the high-luminance areas are each isolated, while the other example describes that the four high-luminance areas are combined. However, the same holds true for the case in which an arbitrary number of high-luminance areas are combined. In such cases, the increasing amount in a backlight luminance level of the combined area is adjusted in accordance with the number of the high-luminance areas that form the combined area.

When the backlight luminance level of the high-luminance area needs to be increased by the luminance control, it is necessary to pay attention to the following. When a current value of an LED light source of the backlight needs to be increased, the maximum increasing amount in the current value is set to a range of 20% to 30% with reference to a current value of a white image displayed on the entire display screen as reference. This prevents a halo, caused when a peak luminance level is increased, from spreading into a peripheral area. The backlight luminance (current values of the LED) at a time when a white image is displayed on the entire display screen is determined on the basis of consumption power of the display device and temperature specifications of the LED light sources. The increasing amount in the current value of each of the LED light sources is determined based on these conditions. When the current values of the LED light sources are increased to values that are close to the upper limit, and the LED light sources are used for a long time, the temperatures of the LED light sources may become higher than an acceptable range of the temperature specifications of the LED light sources and the liquid crystal display device. Thus, the peak luminance timer 9 times the LED light sources being continuously used, when the LED light sources continuously emit light with increased luminance levels for a predetermined time period, the current values of the LED light sources are reset to the original set values.

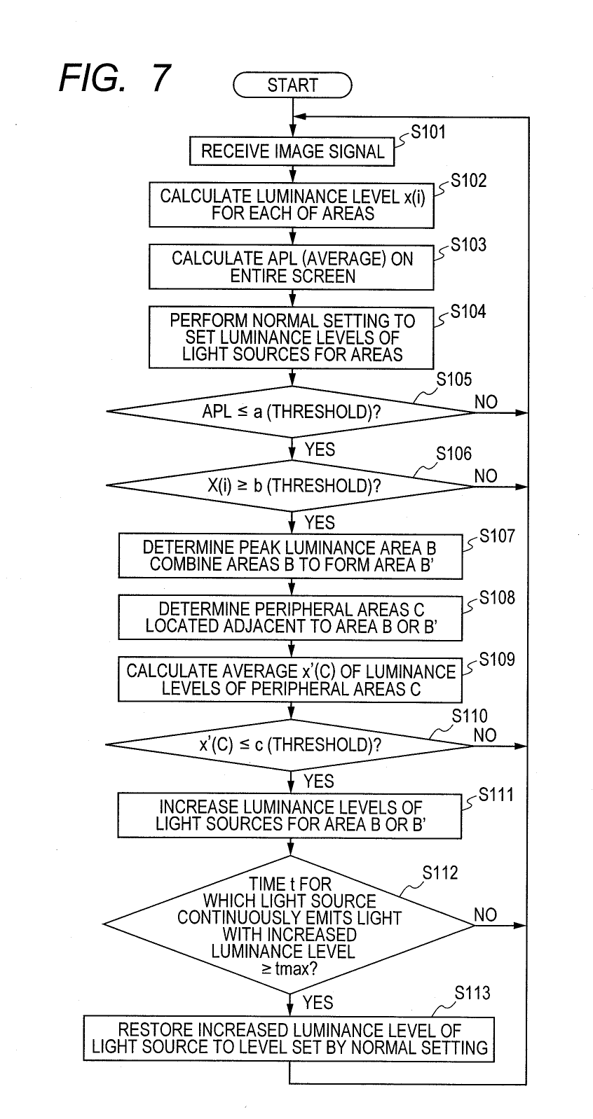

FIG. 7 is a flowchart of the luminance control according to the present embodiment. The microcomputer 16 performs the following control every time the display screen is changed.

In step S101, the image signal receiving unit 1 receives an image signal.

In step S102, the area luminance detector 2 detects a luminance level x(i) of the image signal for each of all areas i and obtains the luminance level x(i) of all areas i.

In step S103, the APL calculator 3 calculates an average APL of the luminance levels x(i) on the display screen.

In step S104, the area controller 6 sets luminance levels of the backlight light sources in accordance with the luminance levels x(i) for the areas i as area control of the backlight. For example, the area controller 6 sets the luminance levels of the backlight light sources so that the set luminance levels are in proportion to the luminance levels x(i) of the areas i. This setting is called “normal setting.”

In step S105, the area controller 6 compares the APL (average luminance level on the entire display screen) with a threshold a. When APL≦a, the control process proceeds to step S106. When APL>a, the control process returns to step S101 and the control is performed on the next screen. For example, the threshold a is set to 20% (it is assumed that the maximum luminance level of the image signal is 100%).

In step S106, the peak luminance detector 4 compares each of the luminance levels x(i) of the areas with a threshold b. When an area that satisfies x(i)≧b exists on the display screen, the control process proceeds to step S107, while when the area that satisfies x(i)≧b does not exist on the display screen, the control process returns to step S101. The threshold b is set to 80%, for example.

In step S107, the peak luminance detector 4 determines, as a peak luminance area B, the area i that satisfies x(i)≧b. In addition, when a plurality of peak luminance areas B are combined on the display screen, the peak luminance detector 4 treats the peak luminance areas B as a combined area B′. It is assumed that the number of the combined areas B is n. The luminance level x(B) of the area B is x(B)≧b. The luminance level x(B′) of the area B′ is x(B′)≧b.

In step S108, the peripheral luminance detector 5 determines, as peripheral areas C, areas located adjacent to the area B (or the area B′). A plurality of the peripheral areas C exists, and four peripheral areas C located adjacent to the isolated area B.

In step S109, the peripheral luminance detector 5 calculates the average x′(C) of the luminance levels x(i) of the plurality of peripheral areas C.

In step S110, the area controller 6 compares the average x′(C) of the luminance levels x(i) of the peripheral areas C with a threshold c. When x′(C)≦c, the control process proceeds to step S111. When x′(C)>c, the control process returns to step S101. The threshold c is 10%, for example.

In step S111, the peak luminance corrector 7 increases a backlight luminance level of the peak luminance area B (or the area B′) or increases a current value of a LED light source corresponding to the peak luminance area B (or the area B′). The increasing amount is determined on the basis of the n number of the combined areas. When the n number of the combined areas is 1, the backlight luminance level or the current value is increased by 20% than the value set by the normal setting. When the n number of the combined areas is 4, the backlight luminance level or the current value is increased by 10% than the value set by the normal setting.

In step S112, the peak luminance timer 9 times a time t for which the LED light source continuously emits light with the increased luminance level, and the peak luminance timer 9 compares the time t with a predetermined time tmax. When t≧tmax, the control process proceeds to step S113. When t<tmax, the control process returns to step S101. The predetermined time tmax is approximately one minute, for example. The time tmax may be determined on the basis of the increasing amount in the luminance level of the LED light source.

In step S113, the area controller 6 restores the increased luminance level of the LED light source to the level set by the normal setting, and the control process returns to step S101.

According to the aforementioned flowchart, the luminance control is performed so that a backlight luminance level of a high-luminance area surrounded by a low-luminance background is increased to a level higher than the normal value. Thereby, it is possible to eliminate a shortfall in the luminance of the high-luminance image. Requirements for the elimination are as follows: the luminance level of the high-luminance area is set to a level that is equal to or higher than the threshold b, and the luminance levels of the peripheral areas are set to levels that are equal to or lower than the threshold c. The luminance control is performed when differences between the luminance level of the high-luminance area and the luminance levels of the peripheral areas are large. Further, the luminance control is performed when the average (APL) of the luminance levels on the entire display screen is equal to or lower than the threshold a and the luminance of the image is in shortage and is visually noticeable. The thresholds a, b and c are mere examples. The thresholds a, b and c are set in accordance with the performance of the display device when necessary.

### Second Embodiment

In the second embodiment a luminance control for a low-luminance area is described in which a low-luminance image is displayed in a high-luminance background image.

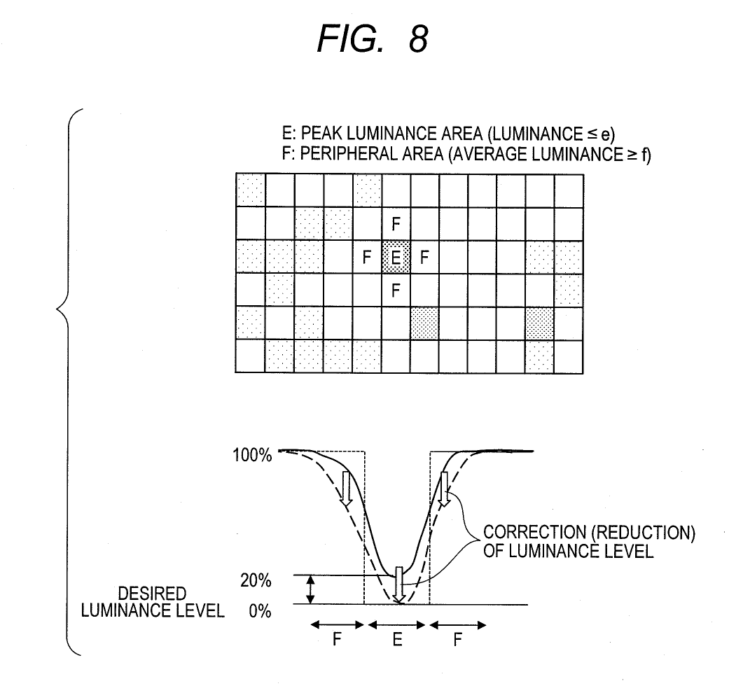

FIG. 8 is a diagram illustrating an example of the display screen on which the luminance control according to the present embodiment is performed. FIG. 8 illustrates the case in which a single low-luminance area is solely present.

The display screen is divided into 12×6 areas. The low-luminance image (black image) is displayed in the high-luminance background image (white image). It is assumed that the low-luminance image is present in a single area E. The area E is hereinafter called a “peak luminance area,” while areas F in which the high luminance image is displayed and located adjacent to the peak luminance area E are hereinafter called “peripheral areas.” In this example, four peripheral areas F are present.

According to the conventional area control, a backlight luminance level of the area E is low, and backlight luminance levels of the areas F are high in the display screen. As a result, the light amount leaking from the areas F into the area E is large. Thus, black floating occurs and an image that is displayed in the area E is brighter than the original image. Four peripheral areas F located adjacent to the area E are present. Thus, if 5% of the light leaks from each of the peripheral areas F into the area E, the luminance level of the area E is increased by 20%. In the present embodiment, the backlight luminance level (current value of the LED light source) of the area E is reduced than that of the conventional area control, thereby prevents black floating from occurring in the image displayed in the area E. Specifically, the light source luminance level is corrected to be lowered by approximately 20% relative to the set value of the backlight luminance level which is determined on the basis of the image signal. If the set backlight luminance level of the area E is already close to 0%, however, the light source luminance level for the area E cannot be reduced. In this case, the backlight luminance levels of the peripheral areas F are reduced to levels lower than that of the conventional area control. This correction enables the backlight luminance level of the area E to become closer to a desired brightness level of 0%.

The example describes that the low-luminance area E is isolated. However, the same holds true for the case in which an arbitrary number of areas E are combined. In such cases, the reducing amounts in backlight luminance levels are adjusted in accordance with the number of the combined areas.

In the luminance control according to the present embodiment, backlight luminance levels (current values of the LED light sources) are reduced. Thus, it is not necessary to consider the acceptable range for the temperature specifications of the LED light sources and the temperature specification of the display device. Therefore, it is not necessary to set the limit for the time for which the LED light sources are continuously used.

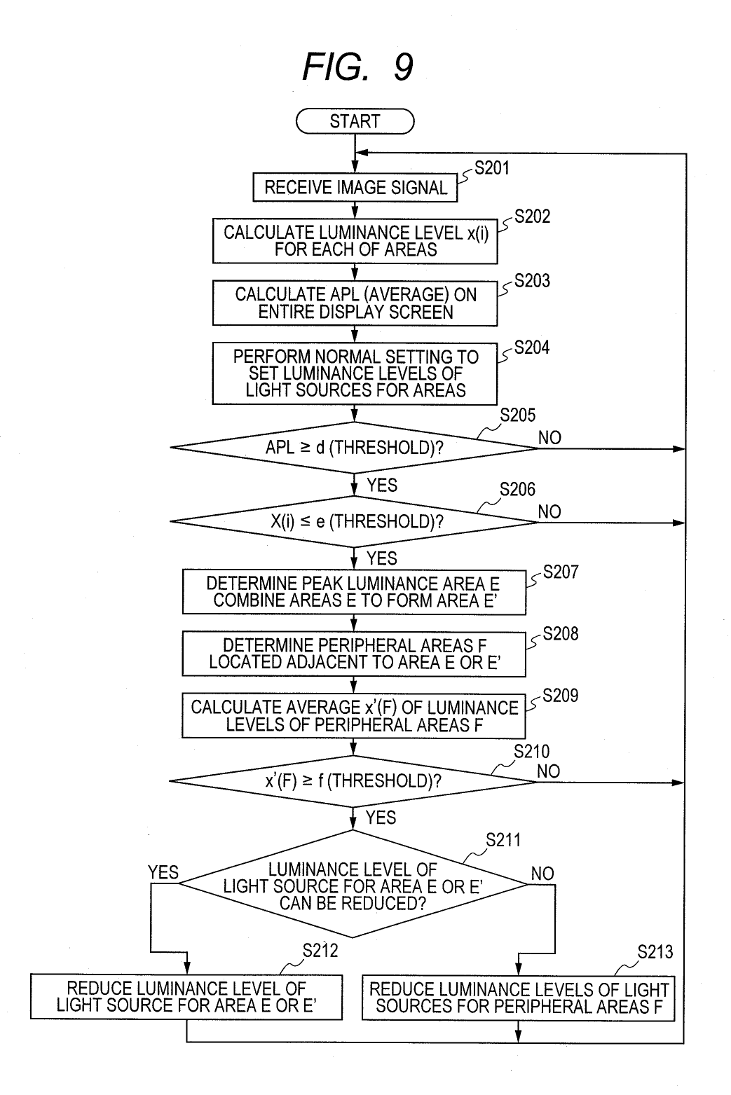

FIG. 9 is a flowchart of the luminance control according to the present embodiment. The microcomputer 16 performs the following control every time the display screen is changed.

In step S201, the image signal receiving unit 1 receives an image signal.

In step S202, the area luminance detector 2 detects a luminance level x(i) of the image signal for each of all areas i and obtains the luminance level x(i) of all areas i

In step S203, the APL calculator 3 calculates the average APL of the luminance levels x(i) on the entire display screen.

In step S204, the area controller 6 sets luminance levels of the backlight light sources in accordance with the luminance levels x(i) of the areas i as area control of the backlight. For example, the area controller 6 sets the luminance levels of the backlight light sources so that the set luminance levels are in proportion to the luminance levels x(i) of the areas i. This setting is called “normal setting.”

In step S205, the area controller 6 compares the APL (average luminance level on the entire display screen) with a threshold d. When APL≧d, the control process proceeds to step S206. When APL<d, the control process returns to step S201, and the control is performed on the next screen. The threshold d is 80%, for example.

In step S206, the peak luminance detector 4 compares each of the luminance levels x(i) of the areas i with a threshold e. When an area that satisfies x(i)≦e exists on the display screen, the control process proceeds to step S207, while when the area that satisfies x(i)≦e does not exist on the display screen, the control process returns to step S201. The threshold e is 20%, for example.

In step S207, the peak luminance detector 4 determines, as a peak luminance area E, the area i that satisfies x(i)≦e. In addition, when a plurality of areas E are combined on the display screen, the peak luminance detector 4 treats the areas E as a combined area E′. It is assumed that the number of the combined areas E is n. The luminance level x(E) of the area E is s(E)≦e. The luminance level x(E′) of the area E′ is s(E′)≦e.

In step S208, the peripheral luminance detector 5 determines, as peripheral areas F, areas located adjacent to the area E (or the area E′), four peripheral areas F exist. The number of the peripheral areas F located adjacent to the isolated area E.

In step S209, the peripheral luminance detector 5 calculates the average x′(F) of the luminance levels x(i) of the plurality of peripheral areas F.

In step S210, the area controller 6 compares the average x′(F) of the luminance levels x(i) of the peripheral areas F with a threshold f. When x′(F)≧f, the control process proceeds to step S211. When x′(F)<f, the control process returns to step S201. The threshold f is 90%, for example.

In step S211, the peak luminance detector 7 determines whether or not the backlight luminance level of the peak luminance area B (or the area B′) can be reduced. If the luminance levels are set to approximately 0% in step S204, the backlight luminance level of the peak luminance area B (or the area B′) cannot be reduced. When the backlight luminance level of the peak luminance area B (or the area B′) can be reduced, the control process proceeds to step S212. When the backlight luminance level of the peak luminance area B (or the area B′) cannot be reduced, the control process proceeds to step S213.

In step S212, the backlight luminance level of the peak luminance area B (or the area B′) or the current value of the LED light source corresponding to the peak luminance area B (or the area B′) is reduced. The reducing amount is determined on the basis of the n number of the combined areas. When the n number of the combined areas is 1, the backlight luminance level of the peak luminance area B is reduced by approximately 20% than the level set by the normal setting. When the n number of the combined areas is 4, the backlight luminance level of the peak luminance area B is reduced by approximately 10% than the level set by the normal setting. Then, the control process returns to step S201.

In step S213, the backlight luminance levels of the peripheral areas F or the current values of the LED light sources are reduced. The reducing amounts are determined on the basis of the n number of the combined areas. When the n number of the combined areas is 1, the backlight luminance levels of the peripheral areas F are reduced by approximately 20% than the levels set by the normal setting. When the n number of the combined areas is 4, the backlight luminance levels of the peripheral areas F are reduced by approximately 10% than the levels set by the normal setting. Then, the control process returns to step S201.

According to the aforementioned flowchart, the luminance control is performed so that a backlight luminance level of a low-luminance area surrounded by a high-luminance background is reduced to a level lower than the level set by the normal setting. Alternatively, the luminance control is performed so that backlight luminance levels of peripheral areas located adjacent to the low-luminance area are reduced to levels lower than the levels set by the normal setting. Accordingly, it is possible to prevent black floating from occurring in a low-luminance image. As requirements for the elimination are as follows: the luminance level of the low-luminance area is set to a level that is equal to or lower than the threshold e, and the luminance levels of the peripheral areas are set to levels that are equal to or higher than the threshold f. The luminance control is performed when differences between the luminance level of the low-luminance area and the luminance levels of the peripheral areas are large. Further, the luminance control is performed when the average (APL) of the luminance levels on the entire display screen is equal to or higher than the threshold d in which the black floating of the image is visually noticeable. The thresholds d, e and f are mere examples. The thresholds d, e and f are set in accordance with the performance of the display device when necessary.

The backlight luminance control according to the present invention is described in the first and second embodiments. The first embodiment describes the case in which a high-luminance image is displayed in a low-luminance background image, while the second embodiment describes the case in which a low-luminance image is displayed in a high-luminance background image. However, it goes without saying that the two embodiments of the luminance control can be independently performed and can be performed in combination.

While we have shown and described the embodiments in accordance with our invention, it should be understood that the disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. A liquid crystal display device comprising:
a liquid crystal panel which displays an image;
a backlight which illuminates the liquid crystal panel with light;
the liquid crystal panel including a display screen divided into a plurality of areas;
the backlight including a plurality of backlight cells that correspond to the areas;
an area controller which individually sets light source luminance levels of the backlight cells in accordance with luminance levels of an image signal for the areas;
a peak luminance detector which detects a peak luminance area in which a luminance level of the area is equal to or higher than a first threshold;
a peripheral luminance detector which detects luminance levels of peripheral areas located adjacent to the peak luminance area; and
a peak luminance corrector which corrects the light source luminance levels of the backlight cells, which is set by the area controller;
wherein, when the average value of the luminance levels of the peripheral areas is equal to or lower than a second threshold, the peak luminance corrector corrects a light source luminance level of a backlight cell corresponding to the peak luminance area so that the corrected luminance level is increased.

2. The liquid crystal display device according to claim 1, further comprising
an APL detector which detects an APL of the luminance levels of the image signal on the entire display screen, wherein
when the APL is equal to or lower than a third threshold, the peak luminance corrector corrects the light source luminance level of the backlight cell corresponding to the peak luminance area so that the corrected luminance level is increased.

3. The liquid crystal display device according to claim 1, wherein,
when the peak luminance detector detects n number of peak luminance areas that are combined, the peak luminance detector treats the detected peak luminance areas as a combined area,
the peripheral luminance detector detects luminance levels of peripheral areas located adjacent to the combined area, and
the peak luminance corrector corrects a light source luminance level of a backlight cell corresponding to the combined area in accordance with the n number of the combined peak luminance areas so that the corrected luminance levels are increased.

4. The liquid crystal display device according to claim 1, further comprising
a timer which measures a period of time for which the light source luminance level of the backlight cell continuously emits light with the increased luminance level, wherein
when the light source luminance level of the backlight cell continuously emits light with the increased luminance level for a predetermined time or more, the area controller restores the light source luminance level of the backlight cell to the originally set luminance level.

5. A liquid crystal display device comprising:
a liquid crystal panel which displays an image;
a backlight which illuminates the liquid crystal panel with light;
the liquid crystal panel including a display screen divided into a plurality of areas;
the backlight including a plurality of backlight cells that correspond to the areas;
an area controller which individually sets light source luminance levels of the backlight cells in accordance with luminance levels of an image signal for the areas;
a peak luminance detector which detects a peak luminance area in which a luminance level of the area is equal to or lower than a fourth threshold;
a peripheral luminance detector which detects luminance levels of peripheral areas located adjacent to the peak luminance area; and
a peak luminance corrector which corrects the light source luminance levels of the backlight cells, which is set by the area controller;
wherein, when the average value of the luminance levels of the peripheral areas is equal to or higher than a fifth threshold, the peak luminance corrector corrects a light source luminance level of a backlight cell corresponding to the peak luminance area so that the corrected luminance level is reduced.

6. The liquid crystal display device according to claim 5, further comprising
an APL detector which detects an APL of the luminance levels of the image signal on the display screen, wherein
when the APL is equal to or higher than a sixth threshold, the peak luminance corrector corrects a light source luminance level of a backlight cell corresponding to the peak luminance area so that the corrected luminance level is reduced.

7. The liquid crystal display device according to claim 5, wherein
when the peak luminance detector detects n number of peak luminance areas that are combined, the peak luminance detector treats the detected peak luminance areas as a combined area,
the peripheral luminance detector detects luminance levels of peripheral areas located adjacent to the combined area, and
the peak luminance corrector corrects a light source luminance level of a backlight cell corresponding to the combined area in accordance with the n number of the combined peak luminance areas so that the corrected luminance level is reduced.

8. The liquid crystal display device according to claim 5, wherein
when the light source luminance level of the backlight cell corresponding to the peak luminance area cannot be reduced, the peak luminance corrector corrects luminance levels of light sources of backlight cells corresponding to the peripheral areas so that the corrected luminance levels are reduced.
